(19) United States
(12) Patent Application Publication
(10) Pub. No.: US 2019/0297561 A1
(43) Pub. Date: Sep. 26, 2019

(54) WIDTH AND CHANNEL NUMBER SIGNALING FOR MULTIBAND DEVICES

(71) Applicant: QUALCOMM Incorporated, San Diego, CA (US)

(72) Inventors: Alfred ASTERJADHI, San Diego, CA (US); George CHERIAN, San Diego, CA (US); Abhishek Pramod PATIL, San Diego, CA (US); Ravi GIDVANI, Fremont, CA (US)

(21) Appl. No.: 16/359,359

(22) Filed: Mar. 20, 2019

Related U.S. Application Data
(60) Provisional application No. 62/645,762, filed on Mar. 20, 2018.

(51) Int. Cl. H04W 48/10; H04W 48/16; H04W 72/04; H04L 1/00; H04L 27/26

(52) U.S. Cl. CPC H04W 48/10; H04W 48/16; H04L 27/2666; H04L 1/0023; H04W 72/0453

(57) ABSTRACT

Certain aspects of the present disclosure provide methods and apparatus for wireless communications and, more particularly, methods and apparatus for providing channel information for multiband operation. The techniques presented herein may help a device (such as an access point) efficiently advertise availability of support in different frequency bands. The signaling techniques presented herein provide, in some cases, for self-contained signaling with sufficient information for a receiving device to efficiently establish operating links in one or more other bands. For example, by providing primary channel width and center channel frequency segments, a receiving device may be able to establish an operating link on another band without lengthy scanning to discover such channels.

### CLAIM OF PRIORITY UNDER 35 U.S.C. § 119

The present application for patent claims benefit of U.S. Provisional Patent Application Ser. No. 62/645,762, filed Mar. 20, 2018, assigned to the assignee hereof and hereby expressly incorporated by reference herein.

### FIELD

Certain aspects of the present disclosure relate generally to wireless communications and, more particularly, systems and methods for providing channel information for multiband operation.

### BACKGROUND

The deployment of wireless local area networks (WLANs) in the home, the office, and various public facilities is commonplace today. Such networks typically employ a wireless access point (AP) that connects a number of wireless stations (STAs) in a specific locality (such as such as home, office, public facility, etc.) to another network, such as the Internet or the like. A set of STAs can communicate with each other through a common AP in what is referred to as a basic service set (BSS).

With the increased use of WLANs, new implementations have been developed to address very high throughput (VHT) operations, such as IEEE 802.11ac. Even with high throughput (HT) and VHT operations available, there is a desire to provide ever increasing capabilities and efficiencies of operations.

As such, IEEE 802.11ax is currently under development and is designed to provide high efficiency (HE) operations to improve overall spectral efficiency in WLANs, especially in dense deployment scenarios. Other standards are also under development, such as IEEE 802.11be, designed to provide extremely high throughput (EHT) operation.

Some devices are able to provide support compliant with multiple versions of these standards and different corresponding operating bands (such as 2.4, 5, or 6 GHz frequency bands). An advantage of such support is that devices may be able to switch to a particular band to provide optimal support, for example, based on overall network loading or based on conditions that favor one band over the other. One challenge is how to advertise this capability, so devices operating in one band can realize support in other operating bands may be available.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects of the present disclosure provide an apparatus for wireless communications. The apparatus generally includes a processing system configured to generate, while the apparatus is communicating in at least one of a first band, a second band, or a third band, at least one frame having a first operation element with at least a first field indicating one or more parameters for operating in the third band supported by the apparatus and an interface configured to output the frame for transmission.

Certain aspects of the present disclosure provide an apparatus for wireless communications. The apparatus generally includes an interface configured to obtain, while the apparatus is communicating in at least one of a first band, a second band, or a third band, at least one frame from a wireless node having a first operation element with at least a first field indicating one or more parameters for operating in the third band supported by the wireless node and a processing system configured to configures the interface for operating in the third band in accordance with the one or more parameters indicated by the first field.

In some cases, the one or more parameters include a first parameter set including at least a first primary channel, a first channel width, and at least a first channel center frequency segment and a second parameter set including at least a second primary channel, a second channel width, and at least a second channel center frequency segment.

In some cases, the one or more parameters include at least one of a primary channel, a channel width, and at least one channel center frequency segment, where the one or more parameters may include at least two channel center frequency segments allowing for channel aggregation.

In some cases, the first operation element includes a high efficiency (HE) operation element and the third band includes a 6 GHz band and the frame may be output for transmission in the 6 GHz band.

In some cases, a high throughput (HT) operation element and a very high throughput (VHT) operation element is excluded if the frame is sent in the 6 GHz band.

In some cases, a high throughput (HT) operation element and a very high throughput (VHT) operation element is included if the frame is sent in the 6 GHz band, only if the HT operation element or VHT operation element provide parameters for operating in the first band or the second band.

In some cases, the parameters include a basic service set (BSS) identifier (BSS ID) for operating in the third band and the BSS ID for operating in the third band is different from a BSS ID for operating in at least one of the first band or second band.

In some cases, an indication of the presence of the first field is indicated in the operation element.

In some cases, the first field is included to indicate the apparatus is available to operate in the third band. In some cases, if the frame is sent on a first channel in the third band, the first field indicates one or more parameters for operating on a second channel in the third band.

In some cases, at least one of a second field indicating one or more parameters for operating in one of the first, second, or third bands or a third field indicating one or more parameters for operating in one of the first, second, or third bands, is included in the frame. In some cases, the element includes an indication of a presence of at least one of the second field or the third field. In some cases, the second field, if present in the frame, includes an indication that the one or more parameters indicated in the second field are for operating in the first band and the third field, if present in the frame, includes an indication that the one or more parameters indicated in the third field are for operating in the second band.

In some cases, the first field indicates one or more parameters for operating on a first channel in the third band and the processing system is further configured to include, in the element, a second field indicating one or more parameters for operating on a second channel in the third band.

Certain aspects of the present disclosure provide an apparatus for wireless communication. The apparatus generally includes a processing system configured to generate, while the apparatus is communicating in at least one of a first band, a second band, or a third band, at least one frame having at least a first operation element and a second operation element and a first interface configured to output the frame for transmission, where the first operation element has at least a first field indicating one or more parameters for operating in a band or channel in which the frame is sent and the second operation element has at least a second field indicating one or more parameters for operating in at least one channel or band different than the band or channel in which the frame is sent.

Certain aspects of the present disclosure provide a method for wireless communication by an apparatus. The method generally includes a processing system configured to generate, while the apparatus is communicating in at least one of a first band, a second band, or a third band, at least one frame having a first operation element with at least a first field indicating one or more parameters for operating in the third band supported by the apparatus and a first interface configured to output the frame for transmission.

Certain aspects of the present disclosure provide a method for wireless communication by an apparatus. The method generally includes obtaining, while the apparatus is communicating in at least one of a first band, a second band, or a third band, at least one frame from a wireless node having a first operation element with at least a first field indicating one or more parameters for operating in the third band supported by the wireless node and configuring the apparatus for operating in the third band in accordance with the one or more parameters indicated by the first field.

Certain aspects of the present disclosure provide a method for wireless communication by an apparatus. The method generally includes generating, while the apparatus is communicating in at least one of a first band, a second band, or a third band, at least one frame having at least a first operation element and a second operation element and outputting the frame for transmission, where the first operation element has at least a first field indicating one or more parameters for operating in a band or channel in which the frame is sent and the second operation element has at least a second field indicating one or more parameters for operating in at least one channel or band different than the band or channel in which the frame is sent.

Certain aspects of the present disclosure provide an apparatus for wireless communication. The apparatus generally includes means for generating, while the apparatus is communicating in at least one of a first band, a second band, or a third band, at least one frame having a first operation element with at least a first field indicating one or more parameters for operating in the third band supported by the apparatus and means for outputting the frame for transmission.

Certain aspects of the present disclosure provide an apparatus for wireless communication. The apparatus generally includes means for obtaining, while the apparatus is communicating in at least one of a first band, a second band, or a third band, at least one frame from a wireless node having a first operation element with at least a first field indicating one or more parameters for operating in the third band supported by the wireless node and means for configuring the apparatus for operating in the third band in accordance with the one or more parameters indicated by the first field.

Certain aspects of the present disclosure provide an apparatus for wireless communication. The apparatus generally includes means for generating, while the apparatus is communicating in at least one of a first band, a second band, or a third band, at least one frame having at least a first operation element and a second operation element and means for outputting the frame for transmission, where the first operation element has at least a first field indicating one or more parameters for operating in a band or channel in which the frame is sent and the second operation element has at least a second field indicating one or more parameters for operating in at least one channel or band different than the band or channel in which the frame is sent.

Certain aspects of the present disclosure provide a wireless station. The wireless station generally includes a processing system configured to generate, while the wireless station is communicating in at least one of a first band, a second band, or a third band, at least one frame having a first operation element with at least a first field indicating one or more parameters for operating in the third band supported by the wireless station and a transmitter configured to transmit the frame.

Certain aspects of the present disclosure provide a wireless station. The wireless station generally includes a receiver configured to receive, while the wireless station is communicating in at least one of a first band, a second band, or a third band, at least one frame from a wireless node having a first operation element with at least a first field indicating one or more parameters for operating in the third band supported by the wireless node and a processing system configured to configure the receiver for operating in the third band in accordance with the one or more parameters indicated by the first field.

Certain aspects of the present disclosure provide a wireless station. The wireless station generally includes a processing system configured to generate, while the apparatus is communicating in at least one of a first band, a second band, or a third band, at least one frame having at least a first operation element and a second operation element and a transmitter configured to transmit the frame, where the first operation element has at least a first field indicating one or more parameters for operating in a band or channel in which the frame is sent and the second operation element has at least a second field indicating one or more parameters for operating in at least one channel or band different than the band or channel in which the frame is sent.

Certain aspects of the present disclosure provide a computer readable medium having instructions stored thereon for generating, while the apparatus is communicating in at least one of a first band, a second band, or a third band, at least one frame having a first operation element with at least a first field indicating one or more parameters for operating in the third band supported by the apparatus and outputting the frame for transmission.

Certain aspects of the present disclosure provide a computer readable medium having instructions stored thereon for obtaining, while the apparatus is communicating in at least one of a first band, a second band, or a third band, at least one frame from a wireless node having a first operation element with at least a first field indicating one or more parameters for operating in the third band supported by the wireless node and configuring an interface for operating in the third band in accordance with the one or more parameters indicated by the first field.

Certain aspects of the present disclosure provide a computer readable medium having instructions stored thereon for generating, while the apparatus is communicating in at least one of a first band, a second band, or a third band, at least one frame having at least a first operation element and a second operation element and outputting the frame for transmission, where the first operation element has at least a first field indicating one or more parameters for operating in a band or channel in which the frame is sent and the second operation element has at least a second field indicating one or more parameters for operating in at least one channel or band different than the band or channel in which the frame is sent.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in accordance with certain aspects of the present disclosure.

FIG. 2 is a block diagram of an example access point and example user terminals, in accordance with certain aspects of the present disclosure.

FIG. 3 is a schematic diagram illustrating an example of an HE operation element in accordance with various aspects of the present disclosure;

FIG. 4A is a schematic diagram illustrating an example of a supported HE MCS and NSS set in accordance with various aspects of the present disclosure;

FIG. 4B is a schematic diagram illustrating an example of a basic HE MCS and NSS set in accordance with various aspects of the present disclosure;

FIG. 5 illustrates example operations for wireless communications by an AP, in accordance with certain aspects of the present disclosure.

FIG. 5A illustrates example components capable of performing the operations shown in FIG. 5, in accordance with certain aspects of the present disclosure.

FIG. 6 illustrates example operations for wireless communications by a STA, in accordance with certain aspects of the present disclosure.

FIG. 6A illustrates example components capable of performing the operations shown in FIG. 6, in accordance with certain aspects of the present disclosure.

FIG. 7 illustrates an example structure for an operation element, in accordance with certain aspects of the present disclosure.

FIG. 8 illustrates another example structure for an operation element, in accordance with certain aspects of the present disclosure.

FIG. 9 illustrates in an example of a field that indicates channel information for an operating frequency band, in accordance with aspects of the present disclosure.

FIG. 10 illustrates example operating information field subfields, in accordance with certain aspects of the present disclosure.

### DETAILED DESCRIPTION

Certain aspects of the present disclosure provide methods and apparatus for communicating support for services in multiple frequency bands. As will be described in greater detail herein, an access point may advertise, via transmission of an operation element in one frequency band, sufficient information to allow a station to efficiently establish operating links in other frequency bands. In some cases, an access point may advertise, in one operating band, sufficient information to allow a station to efficiently establish multiple operating links in that same frequency band.

The techniques presented herein may help address a challenge in systems where multiple bands (such as dual-band, tri-band, or more) or multiple channels are supported. The challenge is how to advertise availability of support in different bands or channels. The signaling techniques presented herein provide, in some cases, for self-contained signaling with sufficient information for a receiving device to efficiently establish operating links in one or more other bands or channels. For example, by providing primary channel width and center channel frequency segments, a receiving device may be able to establish an operating link on another band without lengthy scanning to discover such channels.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers also may be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. The techniques described herein may be utilized in any type of applied to Single Carrier (SC) and SC-MIMO systems.

The teachings herein may be incorporated into (such as implemented within or performed by) a variety of wired or wireless apparatuses (such as nodes). In some aspects, a wireless node implemented in accordance with the teachings herein may include an access point or an access terminal.

An access point (“AP”) may include, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ES S”), a Radio Base Station (“RBS”), or some other terminology.

An access terminal (“AT”) may include, be implemented as, or known as a subscriber station, a subscriber unit, a mobile station, a remote station, a remote terminal, a user terminal, a user agent, a user device, user equipment, a user station, or some other terminology. In some implementations, an access terminal may include a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (such as a cellular phone or smart phone), a computer (such as a laptop), a portable communication device, a portable computing device (such as a personal data assistant), an entertainment device (such as a music or video device, or a satellite radio), a global positioning system device, or any other suitable device that is configured to communicate via a wireless or wired medium. In some aspects, the node is a wireless node. Such wireless node may provide, for example, connectivity for or to a network (such as a wide area network such as the Internet or a cellular network) via a wired or wireless communication link.

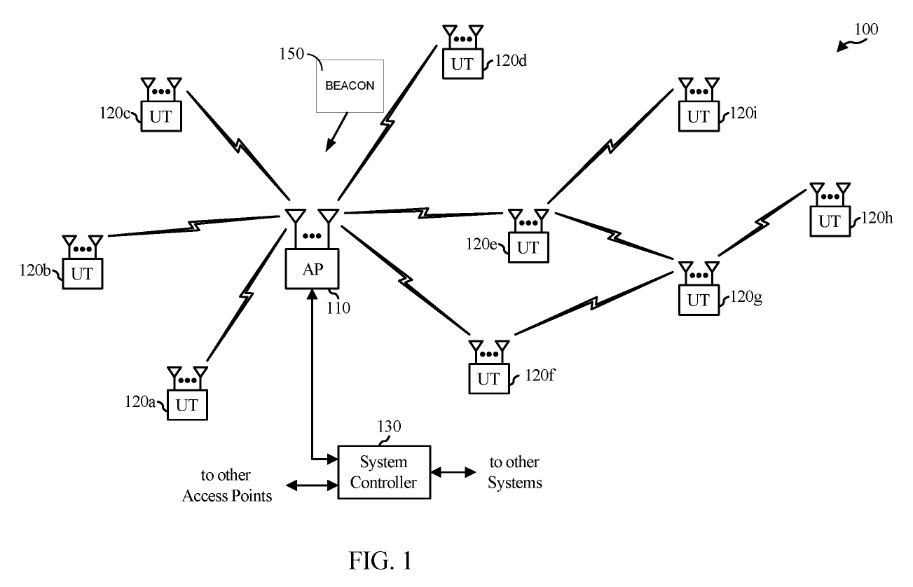

FIG. 1 illustrates a multiple-access multiple-input multiple-output (MIMO) system 100 with access points and user terminals, in which aspects of the present disclosure may be practiced. For example, an access point 110 shown in FIG. 1 that supports multiple operating bands may advertise channel information for such bands (such as in beacon frames 150). A user terminal 120 may use this channel information to establish operating links with the access point 110 in one or more of the bands.

For simplicity, only one access point 110 is shown in FIG. 1. An access point is generally a fixed station that communicates with the user terminals and also may be referred to as a base station or some other terminology. A user terminal may be fixed or mobile and also may be referred to as a mobile station, a wireless device or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal also may communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 also may include some user terminals that do not support SDMA. Thus, for such aspects, an access point (AP) 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≥K≥1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to or receives user-specific data from the access point. In general, each selected user terminal may be equipped with one or multiple antennas (i.e., Nᵤₜ≥1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 also may utilize a single carrier or multiple carriers for transmission. Each user terminal may be equipped with a single antenna (such as in order to keep costs down) or multiple antennas (such as where the additional cost can be supported). The system 100 also may be a TDMA system if the user terminals 120 share the same frequency channel by dividing transmission/reception into different time slots, each time slot being assigned to different user terminal 120.

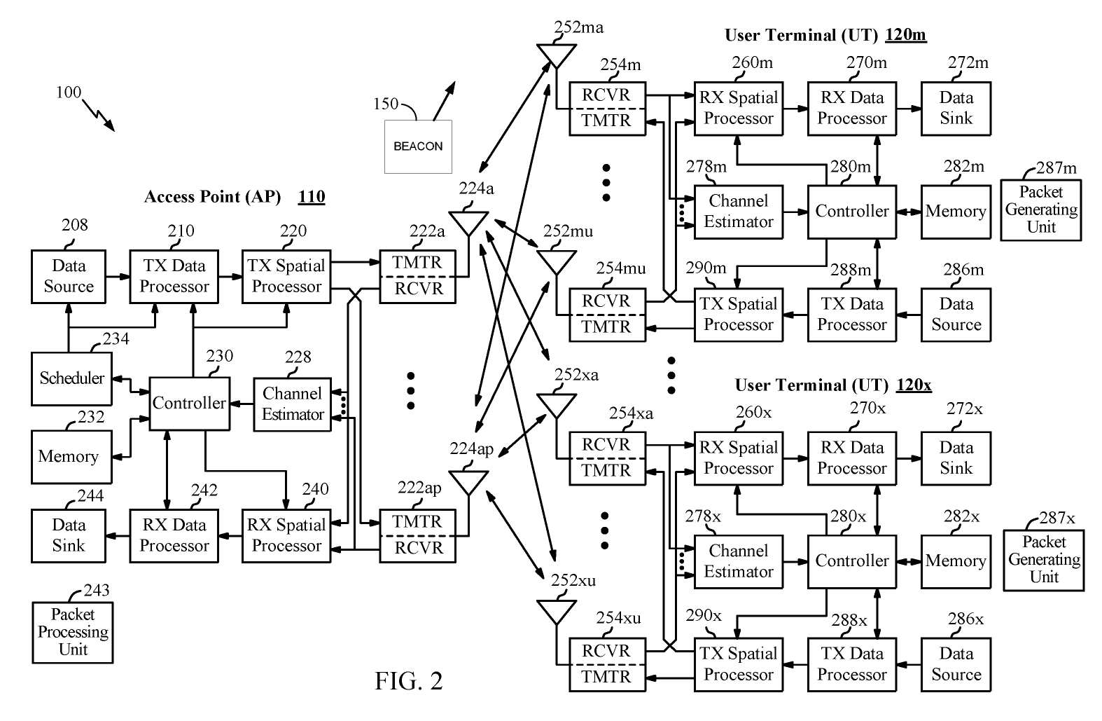

FIG. 2 illustrates a block diagram of access point 110 and two user terminals 120m and 120x in MIMO system 100. The access point 110 is equipped with Nₜ antennas 224a through 224t. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. The term communication generally refers to transmitting, receiving, or both. In the following description, the subscript “dn” denotes the downlink, the subscript “up” denotes the uplink, Nup user terminals are selected for simultaneous transmission on the uplink, Ndn user terminals are selected for simultaneous transmission on the downlink, Nup may or may not be equal to Ndn, and Nup and Ndn may be static values or can change for each scheduling interval. The beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (such as encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut m} antennas. Each transmitter unit (TMTR) 254 receives and processes (such as converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nup user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nup user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nup recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (such as demodulates, deinterleaves, and decodes) each recovered uplink data symbol stream in accordance with the rate used for that stream to obtain decoded data. The decoded data for each user terminal may be provided to a data sink 244 for storage or a controller 230 for further processing.

On the downlink, at access point 110, a TX data processor 210 receives traffic data from a data source 208 for Ndn user terminals scheduled for downlink transmission, control data from a controller 230, and possibly other data from a scheduler 234. The various types of data may be sent on different transport channels. TX data processor 210 processes (such as encodes, interleaves, and modulates) the traffic data for each user terminal based on the rate selected for that user terminal. TX data processor 210 provides Ndn downlink data symbol streams for the Ndn user terminals. A TX spatial processor 220 performs spatial processing (such as a precoding or beamforming, as described in the present disclosure) on the Ndn downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (such as demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (such as the downlink or uplink eigenvectors, eigenvalues, SNR estimates, and so on) to the access point. Controllers 230 and 280 also control the operation of various processing units at access point 110 and user terminal 120, respectively.

Generally, the operation of STAs that support HE (also referred to as HE STAs) in a BSS that supports HE (also referred to as an HE BSS) is controlled by an HE operation element. An HT operation element and a VHT operation element also may be involved in the operation of HE STAs. The HT operation element and VHT operation element are generally involved when the BSS (that supports HE) also supports HT STAs and VHT STAs. In general, all BSSs operating in 5 GHz band should support HT STAs and VHT STAs for backwards compatibility. Similarly, all BSSs operating in the 2.4 Ghz band should support HT STAs for similar reasons. When sent in these bands the HE Operation element may not include operating parameters that are already provided in the HT Operation element and VHT Operation element which are sent in these bands, since this information would be redundant. Such operating parameters include one or more of the following parameters, the primary channel, the Channel width, Channel Center Frequency Segment 0 and Channel Frequency Segment 1.

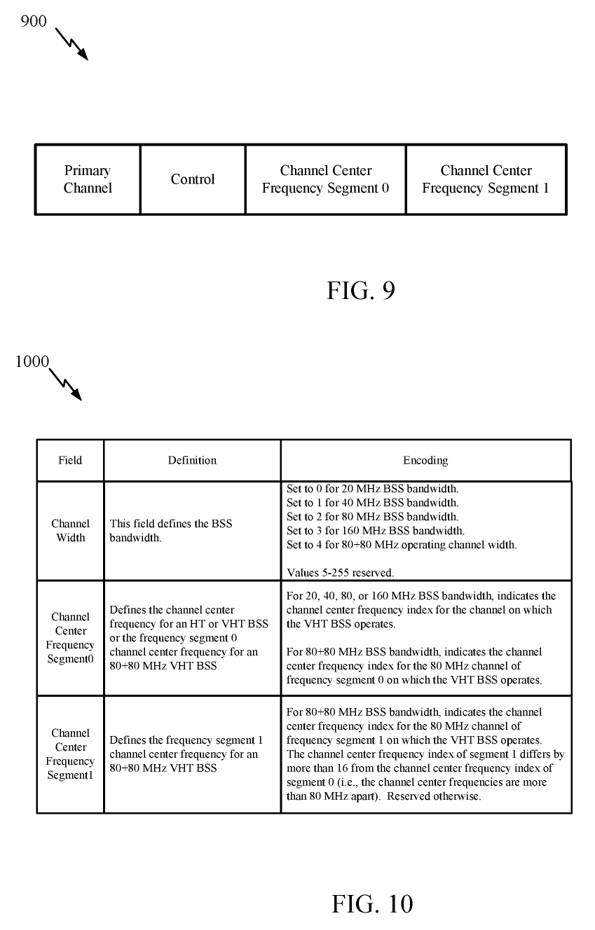

However, BSSs operating in the 6 GHz band need not support HT STAs and VHT STAs as these devices are not allowed to operate in the 6 GHz band. In such case, an HT operation element and VHT operation element may be omitted from Management frames sent by the STA that has set up the BSS (i.e., the AP, with Management frames including the Beacon, Probe Response, (Re-)Association Response, etc.). Similarly, since the BSS does not need to support HT and VHT STAs, HT Capabilities and VHT Capabilities elements can be omitted from these Management frames. Omitting these elements reduces the length of the frames. In such an implementation, the HE operation element may include certain fields from the HT operation element and VHT operation element that allow HE STAs to operate in the 6 GHz band (where HT Operation and VHT operation elements are not sent). These fields may include at least the Primary Channel, Channel Width and Channel Center Frequency Segments 0 and 1 (such as shown in FIG. 9).

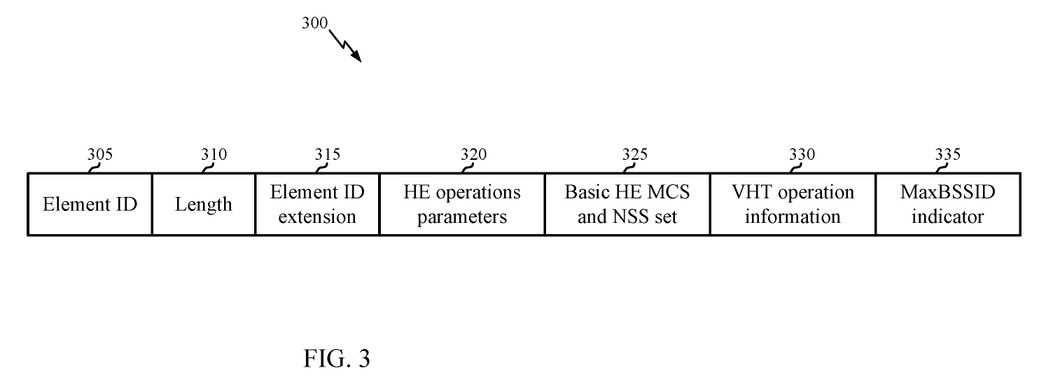

FIG. 3 is a schematic diagram 300 illustrating an example of the format of an HE operation element in accordance with various aspects of the present disclosure. In the schematic diagram 300, the HE operation element includes various fields. Those fields include an element identification (ID) (field 305), a length (field 310), an element ID extension (field 315), an HE operations parameters (field 320), a basic HE modulation coding scheme (MCS) and number of spatial streams (NSS) set (field 325), a VHT operation information (field 330), and a MaxBSSID indicator (field 335). The fields 305, 310, and 315 are typically one octet, the field 320 is typically 4 octets, the field 325 is typically 2 octets, the field 330 is typically 0 or 3 octets, and the field 335 is typically 0 or 1 octet. The schematic diagram 300 is provided by way of example and not of limitation. The HE operation element may include more or fewer fields than those shown in the schematic diagram 300. As such, the HE operation element may include additional fields not shown in the schematic diagram 300 or may have one or more of the fields shown in the schematic diagram 300 removed (a STA may exclude such fields). In one example, the MaxBSSID indicator (field 335) may be omitted. Operation elements for further generation devices (such as EHT) may be constructed following a similar format as the HE operation element shown in FIG. 3 and to provide similar functionalities as described in this invention.

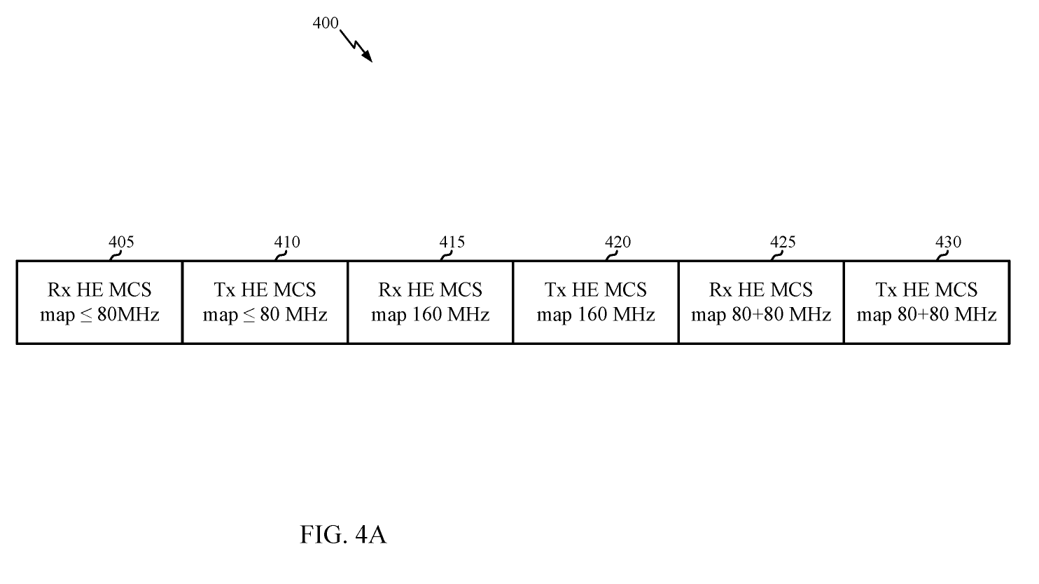

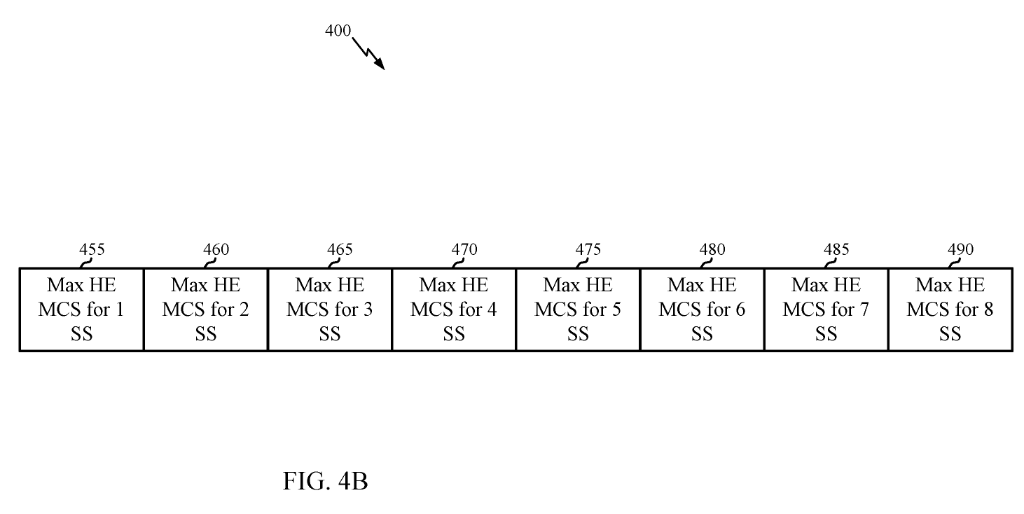

FIG. 4A is a schematic diagram 400 illustrating an example of the format or structure of a supported HE MCS and NSS set field. Such a field may be found in, for example, an HE capabilities element of an MLME-START.request primitive (where MLME refers to medium access control (MAC) sublayer management entity). The supported HE MCS And NSS set field is used to convey the combinations of HE-MCSs and spatial streams that an STA supports for reception and the combinations that it supports for transmission. In the schematic diagram 400, the supported HE MCS and NSS set field includes various subfields. Those subfields include a reception (Rx) HE MCS map≤80 MHz (subfield 405), a transmission (Tx) HE MCS map≤80 MHz (subfield 410), an Rx HE MCS map 160 MHz (subfield 415), a Tx HE MCS map 160 MHz (subfield 420), an Rx HE MCS map 80+80 MHz (subfield 425), and a Tx HE MCS map 80+80 MHz (subfield 430). The subfields 405 and 410 are typically two octets, and the subfields 415, 420, 425, and 430 are typically 0 or 2 octets.

The Rx HE MCS map≤80 MHz indicates a (subfield 405) maximum value of an RXVECTOR parameter MCS of a PLCP protocol data unit or PPDU that can be received at all channel widths less than or equal to 80 MHz supported by the STA for each number of spatial streams. Similarly, the Tx HE MCS map≤80 MHz (subfield 410) indicates a maximum value of an TXVECTOR parameter MCS of a PPDU that can be transmitted at all channel widths less than or equal to 80 MHz supported by the STA for each number of spatial streams.

The Rx HE MCS map 160 MHz (subfield 415) indicates a maximum value of an RXVECTOR parameter MCS of a PPDU that can be received at 160 MHz channel width supported by the STA for each number of spatial streams. Similarly, the Tx HE MCS map 160 MHz (subfield 420) indicates a maximum value of an TXVECTOR parameter MCS of a PPDU that can be transmitted at 160 MHz channel width supported by the STA for each number of spatial streams.

The Rx HE MCS map 80+80 MHz (subfield 425) indicates a maximum value of an RXVECTOR parameter MCS of a PPDU that can be received at 80+80 MHz channel width supported by the STA for each number of spatial streams. Similarly, the Tx HE MCS map 80+80 MHz (subfield 430) indicates a maximum value of an TXVECTOR parameter MCS of a PPDU that can be transmitted at 80+80 MHz channel width supported by the STA for each number of spatial streams.

Each Rx HE MCS map subfield and each Tx HE MCS map subfield described above may have a structure or format as described below in connection with FIG. 3B.

FIG. 4B is a schematic diagram 400 illustrating an example of the format of a basic HE MCS and NSS set in accordance with various aspects of the present disclosure. In the schematic diagram 400, the basic HE MCS and NSS set (which may be an example or indication of content in the field 325 in FIG. 3 or the Rx/Tx HE MCS map subfields described above in FIG. 4A) includes various subfields, one for each of n=1, . . . , 8 spatial streams or SS. The basic HE MCS and NSS set also may be referred to as the HE-MCS and NSS set. Those subfields include a maximum (Max) HE MCS for 1 SS (subfield 455), a Max HE MCS for 2 SS (subfield 460), a Max HE MCS for 3 SS (subfield 465), a Max HE MCS for 4 SS (subfield 470), a Max HE MCS for 5 SS (subfield 475), a Max HE MCS for 6 SS (subfield 480), a Max HE MCS for 7 SS (subfield 485), and a Max HE MCS for 8 SS (subfield 490). Each of the subfields 455, 460, 465, 470, 475, 480, 485, and 490 may include up to 2 bits.

In an aspect, the HE operation element format in FIG. 3 or the Rx/Tx HE MCS map subfields in FIG. 4A may reflect that the number of octets for the basic HE MCS and NSS set is 2 as indicated above. Accordingly, regarding the description of the basic HE MCS and NSS set format in FIG. 4B, the bitmap of size 16 bits. That is, there are 8 subfields of 2 bits each for a total bitmap size of 16 bits. As such, each subfield may have a 2 bit value in the bitmap. Therefore, the basic HE MCS and NSS set format may reflect that the number of bits per Max HE MCS for NSS n subfield is 2 bits. Moreover, the bit numbering for each subfield may correspond to the bit count. For example, for the HE MCS for 1 SS (subfield 455) the bits are B0-B1, for the Max HE MCS for 2 SS (subfield 460) the bits are B2-B3, for the Max HE MCS for 3 SS (subfield 465) the bits are B4-B5, for the Max HE MCS for 4 SS (subfield 470) the bits are B6-B7, for the Max HE MCS for 5 SS (subfield 475) the bits are B8-B9, for the Max HE MCS for 6 SS (subfield 480) the bits are B10-B11, for the Max HE MCS for 7 SS (subfield 485) the bits are B12-B13, and for the Max HE MCS for 8 SS (subfield 490) the bits are B14-B15.

Regarding the HE operation element or the Rx/Tx HE MCS map subfields, the following also may be considered. The Max HE MCS for n SS subfields (where n=1, . . . , 8) may be encoded using two bits as follows:
0 indicates support for HE MCS 0-7 for n spatial streams,
1 indicates support for HE MCS 0-9 for n spatial streams,
2 indicates support for HE MCS 0-11 for n spatial streams, and
3 indicates no support n spatial streams.

For HE BSS operations, an AP or an STA that operates as an AP (such as an AP-STA) that sets up a BSS for HE operations may require a set of minimum capabilities from any STA in order to allow that STA to associate with the AP. In general, the AP that sets up the HE BSS wants to ensure that a set of MCS and NSS and corresponding parameters for HE operations are supported and the AP delivers this information in the HE operation element to STAs that intend to associate or join the AP so that the STAs can commit to supporting these capabilities because the AP will use them to communicate with the STA (such as the AP will broadcast frames using the set and parameters).

Certain aspects of the present disclosure provide methods and apparatus for communicating support for services in multiple frequency bands. As will be described in greater detail herein, an access point may advertise, via transmission of an operation element in one frequency band, sufficient information to allow a station to efficiently establish operating links in other frequency bands.

As noted above, various devices may support multi-band operation, capable of operating in two bands (dual-band operation), three bands (tri-band operation), or more. For example, 802.11ax devices are currently configured to support operating in 2.4 GHz, 5 GHz, or both. In some cases, 802.11ax devices also may be configured to support operating in the 6 GHz band.

Unfortunately, there is currently no efficient signaling at the MAC layer for the Channel Width and channel numbering for operation in 6 GHz. In addition, since these devices can be up to triple-band (support operating in up to 3 bands: 2.4 GHz, 5 GHz, and 6 GHz), it would be beneficial for the AP to be able to indicate the parameters it supports in the additional bands of operation.

Aspects of the present disclosure provide techniques for providing an indication of channelization parameters (such as primary channel width, center frequency, and the like) related to a third band (such as the 6 GHz band), for example, in the HE operation element. As will be described in greater detail below, in some cases, fields contained in the HE operation element may also be used to indicate channel parameters that can be used to establish operating links in the additional bands (such as one or more bands for each of the 2.4, 5, or 6 GHz), and alternatively or additionally to establish one or more operating channels in the same bands.

Using the techniques proposed herein, the behavior described in the sections above that focus on the signaling for a single or dual band device may be extended to more than dual band (such as triple band or more). The functionality described above may be extended to signal information for three or more band operations, where each of the bands can be located in any frequency (such as in the 2.4, 5 or 6 GHz bands). As will be described below, for example, an AP can signal the channel bandwidth, and the channel center frequency indexes for each of the bands in an HE operation element.

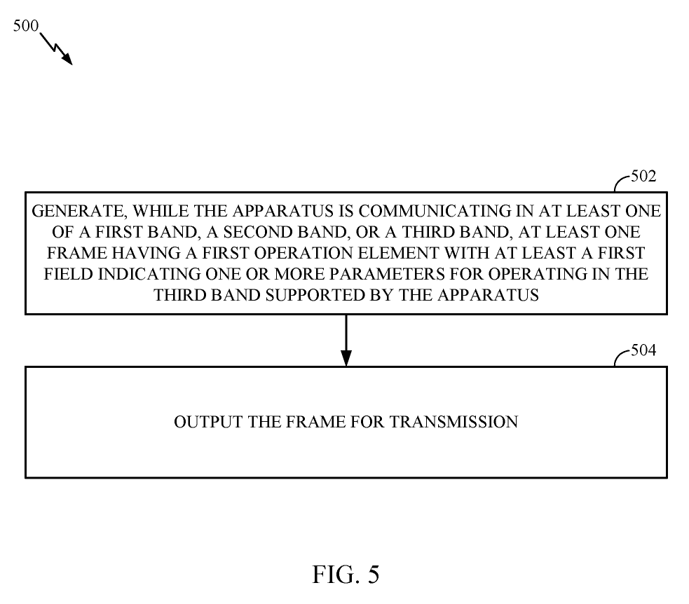

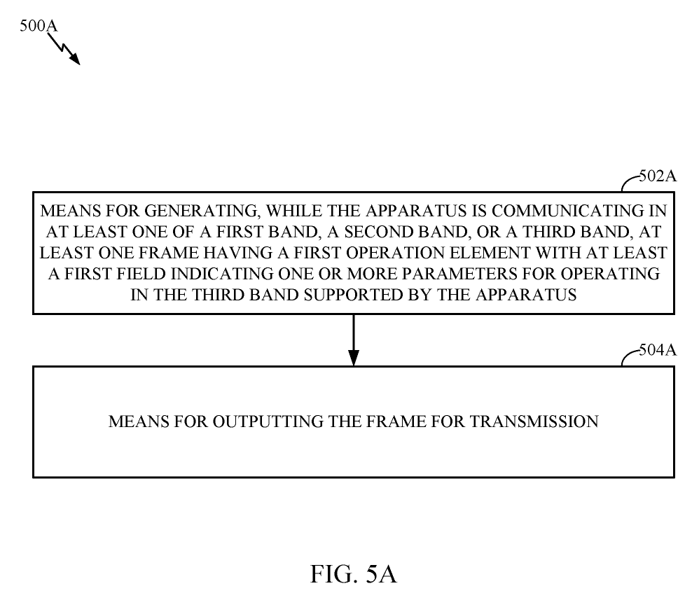

FIG. 5 illustrates example operations 500 for wireless communications by an apparatus, in accordance with certain aspects of the present disclosure. Operations 500 may be performed, for example, by an 802.11ax AP capable of (or currently) operating in three bands (or more).

Operations 500 begin, at 502, by generating, while the apparatus is communicating in at least one of a first band, a second band, or a third band, at least one frame having a first operation element with at least a first field indicating one or more parameters for operating in the third band supported by the apparatus. For example, the operation element may be included in a Management frame, such as a beacon frame, a probe response, or an association (or re-association) response frame etc. At 504, the apparatus outputs the frame for transmission.

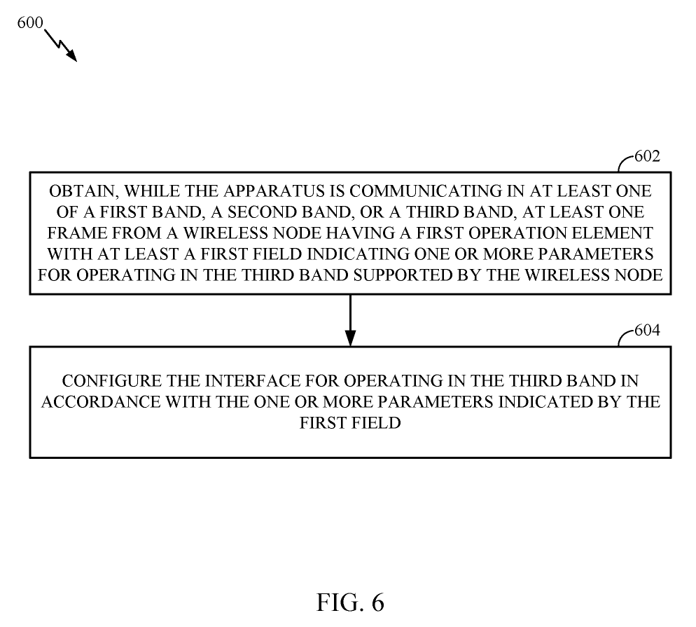

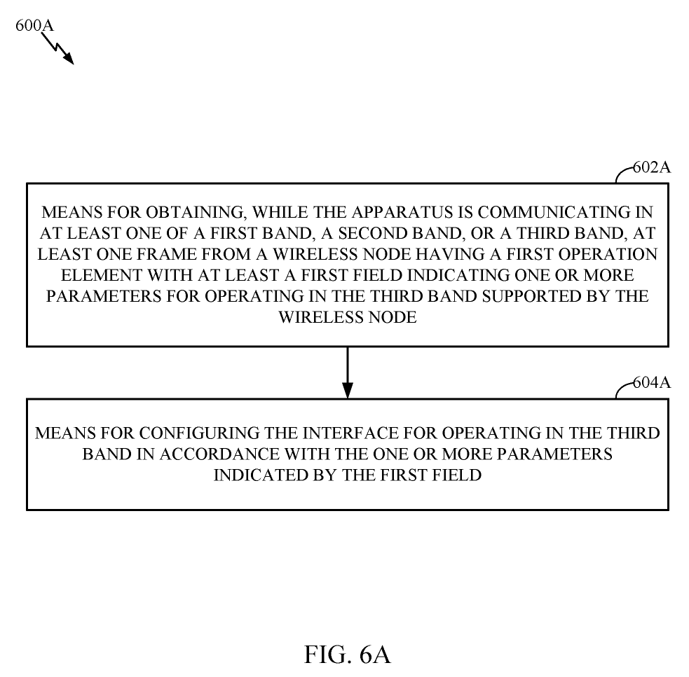

FIG. 6 illustrates example operations 600 for wireless communications by an apparatus, in accordance with certain aspects of the present disclosure. Operations 600 may be performed, for example, by an 802.11ax or 802.11be (non-AP) STA capable of operating in three bands (or more) and communicating with an AP performing operations 500.

Operations 600 begin, at 602, by obtaining, while the apparatus is communicating in at least one of a first band, a second band, or a third band, at least one frame from a wireless node having a first operation element with at least a first field indicating one or more parameters for operating in the third band supported by the wireless node. At 604, the apparatus configures an interface for operating in the third band in accordance with the one or more parameters indicated by the first field. For example, a processor may configure an interface (such as RF front end) according to the channel parameters.

As noted above, aspects of the present disclosure may help provide signaling of channel information to support 6 GHz operation. For example, this channel information may include such as channelization information, channel width and location of a primary channel, as well as the location of the one or more channel (center) frequency segments (which is useful, for example, when operating in a band that has non-contiguous channels). Each segment may refer to the center frequency for each of the contiguous channel sets.

Providing the channelization information (advertising to a STA) as provided herein may additionally help enable dual or triple band support, for example, enabling an AP operating in a first band (such as 2.4 GHz) to advertise availability of operation (“auxiliary operation”) in 5 GHz or 6 GHz. While the channelization information may allow a STA receiving the information to establish an operating link in an additional band, the AP also may include other information helping the STA decide whether to switch to the additional band. For example, the AP also may indicate (identify) additional information in the element, such as for example, modes of operation, systems throughput, average delay, BSS range, and the like, which may aid the STA in deciding whether to switch to the auxiliary channel.

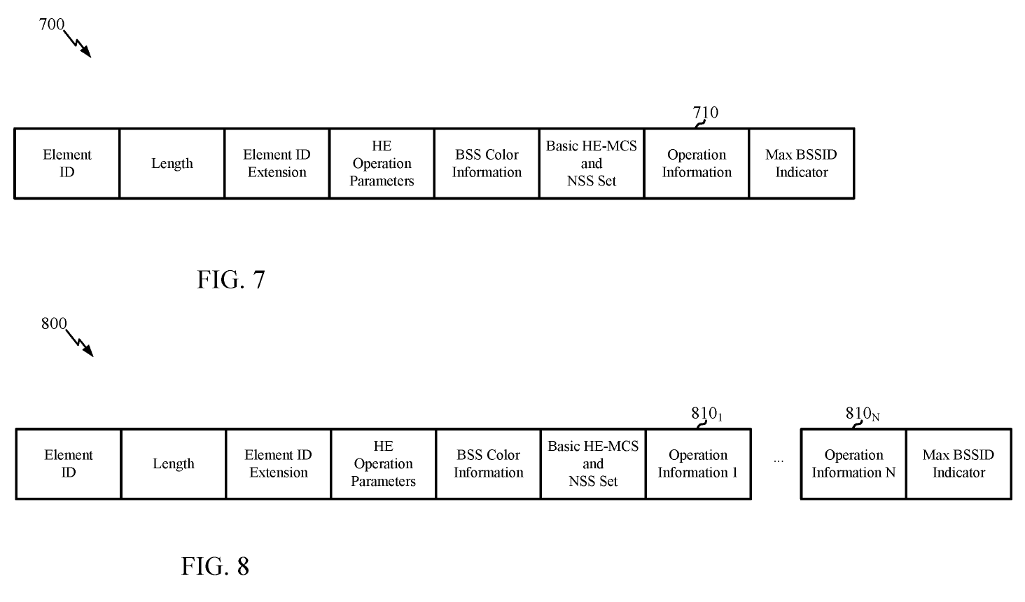

In some cases, this channelization information may be provided via an operation element 700, for example, having the format shown in FIG. 7. In some cases, an operation information field may have an operation information field 710 used to provide an indication of the channel parameters, for example, for operating in 6 GHz.

In certain implementations, more than one Operation Information fields may be present, one for each operating band and/or operating channel. According to the example format shown in FIG. 8, one operation element 800 may have multiple Operation Information fields (810₁-810_{N}), for example, one field for each of the auxiliary/operating bands and/or channels that the AP generating this element is currently operating on (or is available to operate in). The multiple operation information fields may be used to signal channel parameters for different bands or channel parameters for multiple channels within the same band (such as for operating link aggregation). In another implementation, more than one operation elements may be present, each of which may be used to signal channel parameters for different bands or channel parameters for multiple channels within the same band.

In certain implementations the frame may contain more than one (HE) operation elements. For example, the frame may contain one operation element for each of the operating bands and/or operating channels. In such cases, the first element contained in the frame may indicate operating parameters for the BSS for which the frame is being sent, and the rest of the elements may indicate operating parameters for the additional/auxiliary bands and/or channels.

As illustrated in FIG. 9, an operation information field 900 may have fields/subfields that indicate the channel number of the primary channel (such as in the 6 GHz band) and a control field, for example, that includes a channel width field. As illustrated in FIG. 10, the channel width field may include a value to indicate the BSS operating channel bandwidth (such as set to a value to indicate 20 MHz, 40 MHz, 80 MHz, or 160 MHz). As illustrated, in some cases one or more (previously reserved) values of a BSS bandwidth subfield may be used to indicate 6 GHz operation.

As illustrated, the operation information field 900 also may include one or more channel frequency segments. As illustrated in FIG. 10, the channel center frequency segment field 0 may indicate the channel center frequency index for the channel (such as for the 20, 40, or 80, or 80+80 MHz channel) on which the HE BSS operates in the 6 GHz band. When the channel width is 80+80 or 160 MHz then the field indicates the channel center frequency index of the primary 80 MHz.

The channel center frequency segment 1 field may indicates the channel center frequency index of the 160 MHz channel on which the HE BSS operates in the 6 GHz band. When the channel width is 80+80 MHz then this field indicates the channel center frequency index of the secondary 80 MHz.

In some cases, a presence field may be provided to indicate the presence (or absence) of a field with channelization information. For example, such a presence field may be set to 1 to indicate the presence of an Operation Information field. (or set to 0 if an Operation Information field is not present). In some cases, the channelization information provided in the field may be for 6 GHz band. An HE AP or an HE mesh STA may set the Operation Information Present field in the HE operation element to 1 to indicate the BSS information for an additional band or to indicate the BSS information for a channel in the current band, for example, when the element is transmitted in a channel located in the 6 GHz band.

A STA (such as that is an HE AP or an HE mesh STA) that transmits an HE operation element with the Operation Information field present may indicate in the Operation Information field the channel width, channel center frequency segment 0 and channel center frequency segment 1 (if applicable) that it is using in the additional band that the STA is operating in.

Which band is considered the additional band may depend on which band the frame containing the (HE) operation element is sent. For example, the additional band may be the 2.4 GHz band when the operation element is transmitted in the 5 GHz band or the additional band may be the 5 GHz band when the operation element is transmitted in the 2.4 GHz band. Similarly, the additional band(s) may be the 2.4 or 5 GHz bands if the operation element is transmitted in the 6 GHz band (and vice versa).

A STA receiving a frame containing the operation element may use the channelization information contained therein to establish an operating link in the corresponding additional band. For example, a STA (such as an HE STA) may determine the channelization using the information in the channel center frequency segment 0 and channel center frequency segment 1 subfields of the HE operation element when operating in 6 GHz. Channel parameters may include, for example, a band identifier (such as 2.4 GHz, 5 GHz, or 6 GHz), an operating class, geographic location, channel number (such as primary channel), a BSS ID for that particular band, or other information (such as a beacon offset with respect to a beacon in this band), multi-band capability/operation, and the like (such as additional information described above). In some cases, such information may be provided as part of a neighbor (BSSID) report or reduced neighbor report (included in a beacon frame).

The signaling techniques provided herein may allow for signaling parameters used for operating in one or more bands (that an AP may be operating on-or available to operate on), without increasing the size of beacon frames by requiring the addition of extra information elements to provide such information. For example, an AP may selectively include an HT operation element, VHT operation element, or both, depending on what bands is supports or is available to support. In this manner, an AP may be able to indicate it is available to operate in another band and provide channelization information a STA can use to establish an operating link in that other band.

In some cases, an AP sends an HE Operation element in the 6 GHz band, where that AP does not include the VHT operation element and the HT operation element. In such cases, the AP may set a 6 GHz operation field present to 1 and includes the 6 GHz Operation information field to provide channel information for the BSS that is set up in the 6 GHz band (such as the primary channel, the channel width and the channel center frequencies.

In some cases, when operating in the 6 GHz band, an AP may only include a high throughput (HT) operation element and a very high throughput (VHT) operation element if the HT operation element or VHT operation element provide parameters for operating in the 2.4 GHz band or 5 GHz band.

As described herein, an AP that operates in the 2.4 GHz band may include an “HT operation element” that contains primary channel and operating bandwidth/channel width (BW) that AP is employing in 2.4 GHz. An AP that operates in the 5 GHz band may include both HT and VHT operation information fields to indicate the operating bandwidth, and the one or more center frequency segments for operation in 5 GHz. Each center frequency segment may indicate the center frequency for each contiguous channel (such as only one channel center frequency index may be present when there is only one contiguous channel). If an AP supports 6 GHz also, a (VHT) operation information field present in the HE operation element may be used by the AP to indicate it employs HE operation in the 6 GHz band, while using the information delivered in the HT operation element and VHT operation element for providing information of its BSSs in the 2.4 GHz or 5 GHz bands.

Given the VHT operation element with information for 5 GHz operation, and the HT Operation with information for 2.4 GHz or 5 GHz band operation, a similar operation information field present in the HE operation element may be used (repurposed) to provide the information for 6 GHz band operation. For example, this information may include at least the Primary Channel, Channel Width and Channel Center Frequency Segments 0 and 1, such as shown in FIG. 9.

Alternatively, the operation information field may be used by the AP to provide distinct information. For example, the AP may declare that its VHT BSS operates with an operating bandwidth that is different (lesser or greater than) from the operating bandwidth of its HE BSS. An AP may set the HE operation information present field to 1 to include an operation information field with channel information for an additional band, such as the 6 GHz band.

An operation information field for 6 GHz may be provided in various cases. In a first case, if an AP is operating in 2.4 GHz band, presence of this field in the HE operation element may indicate the BW, center frequency segment 0 or center frequency segment 1 the AP is employing in 6 GHz band. In a second case, if the AP is operating in 5 GHz band, the operation information field may be providing channel information for an auxiliary 6 GHz band. In this case, HT/VHT operation information fields may provide information for the current band. In a third case, if the AP is operating in the 6 GHz band (and a frame with the operation information field was sent on the 6 GGz band), this (non HT/VHT) operation information field may provide channel information such as channel width, center frequency, and the like, for the current band.

An AP generally operates in an auxiliary band using the same BSS ID as a current band. In some cases, however, the AP could use different BSS IDs for different operating bands, or even use different BSS IDs for different channels in the same band (such as when the AP is deploying multiple BSSs in the same band but in multiple channels). Therefore, the operation information field providing the operating parameters for 6 GHz also may provide a BSS ID (such as a 6 byte value) used in the current band or an auxiliary band as described above.

An AP may signal, via an HE operation element, support for single band 2.4 GHz, single band 5 GHz, or single band 6 GHz. If an auxiliary band is used, a STA may want to provide auxiliary info for 2.4 GHz or 5 GHz, and indicate that operation information elements for these multiple bands are included. As noted above, multiple operation information fields may be used, for example, after the 6 GHz, then a field for 2.4 GHz, then another field for 5 GHz (such as with one or more auxiliary BSS IDs, one for each of the BSSID that are different from the BSSID that the STA is currently using in the current band).

In some cases, an operation information filed itself may include an indication (such as via one or more bits) of the band(s) for which the channel information is provided (such as ‘00’ for single band, ‘01’ for additional band, ‘10’ for two additional bands-two additional operation information fields). As noted above, operation fields do not need to be for separate bands, but could be for different channels in the same band (such as CH1 and CH16 in the same band such as for link aggregation).

If a separate BSS ID is not provided for an auxiliary band, the assumption may be for a STA to use the same BSS ID. This approach may provide for a seamless transition between bands (such as b/w 2.4, 5, and 6 GHz bands) and the (auxiliary) band a STA transitions to also may inherit properties of the current band (such as security, block acknowledgment session, and the like), with no need to re-associate or authenticate. In another case, if a different BSS ID is provided and the STA is aware of the BSS ID and the new band the AP is operating in, the STA may be able to send a direct association request, which may result in faster roaming between bands.

In some cases, an AP currently operating on one band may enable other bands for various purposes. For example, an AP operating in a DFS (dynamic frequency scaling) channel(s) may start providing quiet periods of time to actively scan for incumbent technologies or to determine if its transmissions might interfere with other technologies operating in the same channel(s). In such a case, the AP may need to enable an auxiliary band for stations so that time sensitive traffic is not impacted during these quiet time periods. For example, if an AP detects 5 GHz and needs to provide quiet time, that AP may need to enable an auxiliary band, so a STA (served by the AP) can transition to the other band until the quiet period is over.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The various operations of methods described above may be performed by any suitable means capable of performing the corresponding functions. The means may include various hardware or software component(s) or module(s), including, but not limited to a circuit, an application specific integrated circuit (ASIC), or processor. Generally, where there are operations illustrated in figures, those operations may have corresponding counterpart means-plus-function components with similar numbering. For example, operations 500 and 600 illustrated in FIGS. 5 and 6 correspond to means 500A and 600A illustrated in FIGS. 5A and 6A.

Means for receiving or means for obtaining may include a receiver (such as the receiver unit 222) or an antenna(s) 224 of the access point 110 or the receiver unit 254 or antenna(s) 252 of the user terminal 120 illustrated in FIG. 2. Means for transmitting or means for outputting may include a transmitter (such as the transmitter unit 222) or an antenna(s) 224 of the access point 110 or the transmitter unit 254 or antenna(s) 252 of the user terminal 120 illustrated in FIG. 2. Means for generating, means for configuring, means for including, means for excluding, means for identifying, or means for determining may include a processing system, which may include one or more processors, such as the RX data processor 242, the TX data processor 210, the TX spatial processor 220, RX spatial processor 240, or the controller 230 of the access point 110 or the RX data processor 270, the TX data processor 288, the TX spatial processor 290, RX spatial processor 260, or the controller 280 of the user terminal 120 illustrated in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, the term “determining” encompasses a wide variety of actions. For example, “determining” may include calculating, computing, processing, deriving, investigating, looking up (such as looking up in a table, a database or another data structure), ascertaining and the like. Also, “determining” may include receiving (such as receiving information), accessing (such as accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as combinations that include multiples of one or more members (aa, bb, or cc).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may include a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein include one or more steps or actions for achieving the described method. The method steps or actions may be interchanged with one another without departing from the scope of the claims. In other words, unless a specific order of steps or actions is specified, the order or use of specific steps or actions may be modified without departing from the scope of the claims.

The functions described may be implemented in hardware, software, firmware, or any combination thereof. If implemented in hardware, an example hardware configuration may include a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (such as keypad, display, mouse, joystick, etc.) also may be connected to the bus. The bus also may link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may include packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, or a computer product separate from the wireless node, all which may be accessed by the processor through the bus interface. Alternatively, or in addition, the machine-readable media, or any portion thereof, may be integrated into the processor, such as the case may be with cache or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may include a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may include non-transitory computer-readable media (such as tangible media). In addition, for other aspects computer-readable media may include transitory computer-readable media (such as a signal). Combinations of the above should also be included within the scope of computer-readable media.

Thus, certain aspects may include a computer program product for performing the operations presented herein. For example, such a computer program product may include a computer-readable medium having instructions stored (or encoded) thereon, the instructions being executable by one or more processors to perform the operations described herein. For certain aspects, the computer program product may include packaging material.

Further, it should be appreciated that modules or other appropriate means for performing the methods and techniques described herein can be downloaded or otherwise obtained by a user terminal or base station as applicable. For example, such a device can be coupled to a server to facilitate the transfer of means for performing the methods described herein. Alternatively, various methods described herein can be provided via storage means (such as RAM, ROM, a physical storage medium such as a compact disc (CD) or floppy disk, etc.), such that a user terminal or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communication, comprising:
a processing system configured to generate, while the apparatus is communicating in at least one of a first band, a second band, or a third band, at least one frame having a first operation element with at least a first field indicating one or more parameters for operating in the third band supported by the apparatus; and
a first interface configured to output the frame for transmission.

2. The apparatus of claim 1, wherein the one or more parameters comprise:
a first parameter set including at least a first primary channel, a first channel width, and at least a first channel center frequency segment; and
a second parameter set including at least a second primary channel, a second channel width, and at least a second channel center frequency segment.

3. The apparatus of claim 1, wherein the one or more parameters comprise at least one of a primary channel, a channel width, and at least one channel center frequency segment.

4. The apparatus of claim 3, wherein the one or more parameters comprise at least two channel center frequency segments allowing for channel aggregation.

5. The apparatus of claim 1, wherein:
the first operation element comprises a high efficiency (HE) operation element; and
the third band comprises a 6 GHz band.

6. The apparatus of claim 5, wherein the frame is output for transmission in the 6 GHz band.

7. The apparatus of claim 5, wherein the processing system is configured to exclude, from the frame, a high throughput (HT) operation element and a very high throughput (VHT) operation element if the frame is sent in the 6 GHz band.

8. The apparatus of claim 5, wherein the processing system is configured to include, in the frame, a high throughput (HT) operation element and a very high throughput (VHT) operation element if the frame is sent in the 6 GHz band, only if the HT operation element or VHT operation element provide parameters for operating in the first band or the second band.

9. The apparatus of claim 1, wherein:
the parameters include a basic service set (BSS) identifier (BSS ID) for operating in the third band; and
the BSS ID for operating in the third band is different from a BSS ID for operating in at least one of the first band or second band.

10. The apparatus of claim 1, wherein:
the processing system is further configured to provide an indication in the operation element of the presence of the first field in the operation element.

11. The apparatus of claim 1, wherein the processing system is configured to include the first field to indicate the apparatus is available to operate in the third band.

12. The apparatus of claim 11, wherein, if the frame is sent on a first channel in the third band, the first field indicates one or more parameters for operating on a second channel in the third band.

13. The apparatus of claim 1, wherein the processing system is further configured to include, in the frame, at least one of:
a second field indicating one or more parameters for operating in one of the first, second, or third bands; or
a third field indicating one or more parameters for operating in one of the first, second, or third bands.

14. The apparatus of claim 13, wherein the processing system includes, in the element, an indication of a presence of at least one of the second field or the third field.

15. The apparatus of claim 13, wherein:
the second field, if present in the frame, includes an indication that the one or more parameters indicated in the second field are for operating in the first band; and
the third field, if present in the frame, includes an indication that the one or more parameters indicated in the third field are for operating in the second band.

16. The apparatus of claim 1, wherein:
the first field indicates one or more parameters for operating on a first channel in the third band; and
the processing system is further configured to include, in the element, a second field indicating one or more parameters for operating on a second channel in the third band.

17. An apparatus for wireless communication, comprising:
an interface configured to obtain, while the apparatus is communicating in at least one of a first band, a second band, or a third band, at least one frame from a wireless node having a first operation element with at least a first field indicating one or more parameters for operating in the third band supported by the wireless node; and
a processing system configured to configure the interface for operating in the third band in accordance with the one or more parameters indicated by the first field.

18. The apparatus of claim 17, wherein the one or more parameters comprise:
a first parameter set including at least a first primary channel, a first channel width, and at least a first channel center frequency segment; and
a second parameter set including at least a second primary channel, a second channel width, and at least a second channel center frequency segment.

19. The apparatus of claim 17, wherein the one or more parameters comprise at least one of a primary channel, a channel width, and at least one channel center frequency segment.

20. The apparatus of claim 19, wherein the one or more parameters comprise at least two channel center frequency segments allowing for channel aggregation.

21. The apparatus of claim 17, wherein:
the first operation element comprises a high efficiency (HE) operation element; and
the third band comprises a 6 GHz band.

22. The apparatus of claim 21, wherein the frame is output for transmission in the 6 GHz band.

23. The apparatus of claim 17, wherein:
the parameters include a basic service set (BSS) identifier (BSS ID) for operating in the third band; and
the BSS ID for operating in the third band is different from a BSS ID for operating in at least one of the first band or second band.

24. The apparatus of claim 17, wherein:
the processing system is further configured to provide an indication in the operation element of the presence of the first field in the operation element.

25. The apparatus of claim 17, wherein:
the frame was obtained while the apparatus was operating on a first channel in the third band;
the first field indicates one or more parameters for operating on a second channel in the third band; and
the processing system is configured to configure the interface for operating on the second channel in the third band.

26. The apparatus of claim 17, wherein:
the frame also has at least one of a second field indicating one or more parameters for operating in the first band or a third field indicating one or more parameters for operating in the second band; and
the processing system is also configured to at least one of: configure the interface for operating in the first band in accordance with the one or more parameters indicated by the second field or configure the interface for operating in the second band in accordance with the one or more parameters indicated by the third field.

27. An apparatus for wireless communication, comprising:
a processing system configured to generate, while the apparatus is communicating in at least one of a first band, a second band, or a third band, at least one frame having at least a first operation element and a second operation element; and
a first interface configured to output the frame for transmission, wherein the first operation element has at least a first field indicating one or more parameters for operating in a band or channel in which the frame is sent and the second operation element has at least a second field indicating one or more parameters for operating in at least one channel or band different than the band or channel in which the frame is sent.

28. The apparatus of claim 27, wherein the one or more parameters in at least one of the first or second operation elements comprise:
a first parameter set including at least a first primary channel, a first channel width, and at least a first channel center frequency segment; and
a second parameter set including at least a second primary channel, a second channel width, and at least a second channel center frequency segment.

29. The apparatus of claim 27, wherein the one or more parameters in at least one of the first or second operation elements comprise at least one of a primary channel, a channel width, and at least one channel center frequency segment.

30. A method for wireless communication by an apparatus, comprising:
a processing system configured to generate, while the apparatus is communicating in at least one of a first band, a second band, or a third band, at least one frame having a first operation element with at least a first field indicating one or more parameters for operating in the third band supported by the apparatus; and
a first interface configured to output the frame for transmission.

31-93. (canceled)
